(19) United States
(12) Patent Application Publication
(10) Pub. No.: US 2025/0069228 A1
(43) Pub. Date: Feb. 27, 2025

(54) SYSTEMS AND METHODS FOR LESION REGION IDENTIFICATION

(71) Applicant: SHANGHAI UNITED IMAGING HEALTHCARE CO., LTD., Shanghai (CN)

(72) Inventors: Runxia MA, Shanghai (CN); Chao WANG, Shanghai (CN); Xiaoyue GU, Shanghai (CN); Zijun JI, Shanghai (CN); Yulin JIANG, Shanghai (CN); Huayang LIU, Shanghai (CN)

(73) Assignee: SHANGHAI UNITED IMAGING HEALTHCARE CO., LTD., Shanghai (CN)

(21) Appl. No.: 18/942,756

(22) Filed: Nov. 10, 2024

Related U.S. Application Data
(63) Continuation of application No. PCT/CN2023/097379, filed on May 31, 2023.

(30) Foreign Application Priority Data
May 31, 2022 (CN) 202210610225.3
Jun. 22, 2022 (CN) 202210710354.X

(51) Int. Cl. G06T 7/00; G06T 7/11

(52) U.S. Cl. CPC G06T 7/0014; G06T 7/11; G06T 2207/20081; G06T 2207/20112; G06T 2207/20221; G06T 2207/30096

(57) ABSTRACT

The present disclosure provides methods and systems for lesion region identification. The methods may include identifying a target region corresponding to at least one reference organ from a first medical image of a target subject. The methods may include determining, based on the target region, a reference threshold used for lesion detection. The methods may further include identifying, based on the reference threshold, a lesion region from the first medical image.

### CROSS-REFERENCE TO RELATED APPLICATIONS

This application is a continuation of International Application No. PCT/CN2023/097379, filed on May 31, 2023, which claims priority to Chinese Patent Application No. 202210610225.3, filed on May 31, 2022, and Chinese Patent Application No. 202210710354.X, filed on Jun. 22, 2022, the contents of each of which are incorporated herein by reference.

### TECHNICAL FIELD

The present disclosure generally relates to image processing, and more particularly, relates to systems and methods for lesion region identification.

### BACKGROUND

Medical imaging techniques (e.g., a computed tomography (CT) technique, a positron emission tomography (PET) technique, a magnetic resonance (MR) technique, etc.) may be used to non-invasively provide detection information (e.g., anatomical information, functional information, etc.), which provides effectively technical support for evaluating a status of a target subject. For example, a doctor may segment a region of interest (ROI) (e.g., a lesion region) from a medical image of the target subject acquired using the medical imaging techniques, and determine the status of the target subject based on the ROI. However, the doctor usually manually segments the ROI, or uses an empirical value as a reference threshold (e.g., a standard uptake value (SUV) threshold) to identify the ROI, which reduces the accuracy of the lesion region identification.

Therefore, it is desirable to provide systems and methods for automatically identifying the lesion region, thereby improving the efficiency and accuracy of the lesion region identification.

### SUMMARY

In an aspect of the present disclosure, a method for lesion region identification is provided. The method may be implemented on a computing device having at least one processor and at least one storage device. The method may include identifying a target region corresponding to at least one reference organ from a first medical image of a target subject. The method may include determining, based on the target region, a reference threshold used for lesion detection. The method may further include identifying, based on the reference threshold, a lesion region from the first medical image.

In some embodiments, the identifying a target region corresponding to at least one reference organ from a first medical image of a target subject may include generating a segmentation image of the at least one reference organ by segmenting the at least one reference organ from a second medical image of the target subject, the second medical image being acquired using a second imaging modality different from a first imaging modality corresponding to the first medical image; and identifying the target region from the first medical image based on the segmentation image.

In some embodiments, the identifying a target region corresponding to at least one reference organ from a first medical image of a target subject may include identifying the target region from the first medical image by inputting the first medical image into a reference organ segmentation model, the reference organ segmentation model being a trained machine learning model.

In some embodiments, the determining, based on the target region, a reference threshold used for lesion detection may include identifying, from the first medical image, a second target region corresponding to one or more normal organs; determining, based on the first medical image and the second target region, a comparison coefficient; and determining, based on the target region and the comparison coefficient, the reference threshold.

In some embodiments, the determining, based on the first medical image and the second target region, a comparison coefficient may include determining a remaining region of the first medical image based on the first medical image and the second target region; determining a first mean value of standard uptake values (SUVs) of elements in the remaining region of the first medical image; determining a second mean value of SUVs of elements in the first medical image; and determining the comparison coefficient based on the first mean value and the second mean value.

In some embodiments, the determining, based on the target region and the comparison coefficient, the reference threshold may include obtaining SUVs of elements in the target region; determining a mean value and a standard variance value of the SUVs; and determining the reference threshold based on the mean value, the standard variance value, and the comparison coefficient.

In some embodiments, the method may further include generating, based on the lesion region, a lesion distribution image; obtaining at least one reference segmentation image, the at least one reference segmentation image including at least one of a first segmentation image of organs of the target subject or a second segmentation image of body parts of the target subject; and determining, based on the lesion distribution image and the at least one reference segmentation image, position information of the lesion region in the target subject.

In some embodiments, the position information may include: which organ or body part that the lesion region belongs to, at least one of a location, a contour, a shape, a height, a width, a thickness, an area, a volume, or a ratio of height to width of the lesion region in the target subject.

In some embodiments, the obtaining at least one reference segmentation image may include at least one of: generating the first segmentation image by segmenting the organs of the target subject from a second medical image of the target subject; or generating the second segmentation image by segmenting the body parts of the target subject from a third medical image of the target subject.

In some embodiments, the at least one reference segmentation image may include the first segmentation image and the second segmentation image. The determining, based on the lesion distribution image and the at least one reference segmentation image, position information of the lesion region in the target subject may include generating a fusion image by fusing the first segmentation image and the second segmentation image, the fusion image being a segmentation image of the organs and the body parts of the target subject; generating a registered image by registering the fusion image and the lesion distribution image; and determining, based on the registered image, the position information of the lesion region in the target subject.

In some embodiments, the generating a registered image by registering the fusion image and the lesion distribution image may include generating a preliminary point cloud model representing the target subject based on the fusion image; generating a target point cloud model by transforming the preliminary point cloud model; generating a transformation image by transforming the fusion image based on the target point cloud model; and generating the registered image by fusing the transformation image and the lesion distribution image.

In some embodiments, the at least one reference segmentation image may include the first segmentation image. The determining, based on the lesion distribution image and the at least one reference segmentation image, position information of the lesion region in the target subject may include generating a registered first segmentation image by registering the first segmentation image and the lesion distribution image; generating a first fusion image by fusing the registered first segmentation image and the lesion distribution image; and determining, based on the first fusion image, the position information of the lesion region in the target subject.

In some embodiments, the at least one reference segmentation image may include the second segmentation image. The determining, based on the lesion distribution image and the at least one reference segmentation image, position information of the lesion region in the target subject may include generating a registered second segmentation image by registering the second segmentation image and the lesion distribution image; generating a second fusion image by fusing the registered second segmentation image and the lesion distribution image; and determining, based on the second fusion image, the position information of the lesion region in the target subject.

In some embodiments, the method may further include generating a report based on the position information of the lesion region in the target subject, the report including text descriptions regarding the position information.

In another aspect of the present disclosure, a system for lesion region identification is provided. The system may include at least one storage device including a set of instructions; and at least one processor configured to communicate with the at least one storage device. When executing the set of instructions, the at least one processor may be configured to direct the system to perform operations. The operations may include identifying a target region corresponding to at least one reference organ from a first medical image of a target subject. The operations may include determining, based on the target region, a reference threshold used for lesion detection. The operations may further include identifying, based on the reference threshold, a lesion region from the first medical image.

In still another aspect of the present disclosure, a system for lesion region identification is provided. The system may include an identification module and a determination module. The identification module may be configured to identify a target region corresponding to at least one reference organ from a first medical image of a target subject. The determination module may be configured to determine, based on the target region, a reference threshold used for lesion detection. The identification module may be further configured to identify, based on the reference threshold, a lesion region from the first medical image.

In still another aspect of the present disclosure, a non-transitory computer readable medium for lesion region identification is provided. The non-transitory computer readable medium may comprise executable instructions that, when executed by at least one processor, direct the at least one processor to perform a method. The method may include identifying a target region corresponding to at least one reference organ from a first medical image of a target subject. The method may include determining, based on the target region, a reference threshold used for lesion detection. The method may further include identifying, based on the reference threshold, a lesion region from the first medical image.

In still aspect of the present disclosure, a method for determining position information of a lesion region is provided. The method may be implemented on a computing device having at least one processor and at least one storage device. The method may include generating, based on a lesion region, a lesion distribution image. The method may include obtaining at least one reference segmentation image. The at least one reference segmentation image may include at least one of a first segmentation image of organs of a target subject or a second segmentation image of body parts of the target subject. The method may further include determining, based on the lesion distribution image and the at least one reference segmentation image, position information of the lesion region in the target subject.

In another aspect of the present disclosure, a system for determining position information of a lesion region is provided. The system may include at least one storage device including a set of instructions; and at least one processor configured to communicate with the at least one storage device. When executing the set of instructions, the at least one processor may be configured to direct the system to perform operations. The operations may include generating, based on a lesion region, a lesion distribution image. The operations may include obtaining at least one reference segmentation image, the at least one reference segmentation image including at least one of a first segmentation image of organs of a target subject or a second segmentation image of body parts of the target subject. The operations may further include determining, based on the lesion distribution image and the at least one reference segmentation image, position information of the lesion region in the target subject.

In still another aspect of the present disclosure, a non-transitory computer readable medium for lesion region identification is provided. The non-transitory computer readable medium may comprise executable instructions that, when executed by at least one processor, direct the at least one processor to perform a method. The method may include generating, based on a lesion region, a lesion distribution image. The method may include obtaining at least one reference segmentation image. The at least one reference segmentation image may include at least one of a first segmentation image of organs of a target subject or a second segmentation image of body parts of the target subject. The method may further include determining, based on the lesion distribution image and the at least one reference segmentation image, position information of the lesion region in the target subject.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary imaging system according to some embodiments of the present disclosure;

FIG. 2 is a block diagram illustrating an exemplary processing device according to some embodiments of the present disclosure;

FIG. 3 is a flowchart illustrating an exemplary process for lesion region identification according to some embodiments of the present disclosure;

FIG. 4 is a flowchart illustrating an exemplary process for determining a reference threshold according to some embodiments of the present disclosure;

FIG. 5 is a schematic diagram illustrating an exemplary process for lesion region identification according to some embodiments of the present disclosure;

FIG. 6 is a flowchart illustrating an exemplary process for determining position information of a lesion region according to some embodiments of the present disclosure;

FIG. 7 is a flowchart illustrating an exemplary process for determining position information of a lesion region according to some embodiments of the present disclosure;

FIG. 8A is a flowchart illustrating an exemplary process for determining position information of a lesion region according to some embodiments of the present disclosure;

FIG. 8B is a schematic diagram illustrating an exemplary process for determining position information of a lesion region according to some embodiments of the present disclosure;

FIG. 9A is a flowchart illustrating an exemplary process for determining position information of a lesion region according to some embodiments of the present disclosure;

FIG. 9B is a schematic diagram illustrating an exemplary process for determining position information of a lesion region according to some embodiments of the present disclosure; and

FIG. 10 is a schematic diagram illustrating an exemplary computing device according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economics of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

In the present disclosure, the term “image” may refer to a two-dimensional (2D) image, a three-dimensional (3D) image, or a four-dimensional (4D) image (e.g., a time series of 3D images). In some embodiments, the term “image” may refer to an image of a region (e.g., an ROI) of a subject. In some embodiments, the image may be a medical image, an optical image, etc.

In the present disclosure, a representation of a subject (e.g., an object, a patient, or a portion thereof) in an image may be referred to as “subject” for brevity. For instance, a representation of an organ, tissue (e.g., a heart, a liver, a lung), or an ROI in an image may be referred to as the organ, tissue, or ROI, for brevity. Further, an image including a representation of a subject, or a portion thereof, may be referred to as an image of the subject, or a portion thereof, or an image including the subject, or a portion thereof, for brevity. Still further, an operation performed on a representation of a subject, or a portion thereof, in an image may be referred to as an operation performed on the subject, or a portion thereof, for brevity. For instance, a segmentation of a portion of an image including a representation of an ROI from the image may be referred to as a segmentation of the ROI for brevity.

Normally, a medical image of a target subject acquired using medical imaging techniques may be segmented by a user (e.g., a doctor, a technician, etc.). For example, the user may manually segment an ROI (e.g., a lesion region) from the medical image of the target subject. As another example, the user may use an empirical value as a reference threshold (e.g., an SUV threshold) to identify the ROI. However, these conventional approaches are susceptible to human errors or subjectivity and have limited accuracy. In addition, position information (e.g., a specific organ/body part) of the ROI may be manually determined by the user, which is inefficient and susceptible to human errors.

In order to reduce labor consumption and improve the efficiency and accuracy of the lesion region identification, the present disclosure provides systems and methods for lesion region identification. The methods may include identifying a target region corresponding to at least one reference organ from a first medical image of a target subject. The methods may include determining, based on the target region, a reference threshold used for lesion detection. Further, the methods may include identifying, based on the reference threshold, a lesion region from the first medical image. Therefore, the lesion region may be automatically identified, which may reduce the labor consumption and the dependence on the experience of users, and improve the efficiency and accuracy of the lesion region identification.

In addition, position information of the lesion region may be automatically determined, which may further reduce the labor consumption, and improve the efficiency of the lesion region identification.

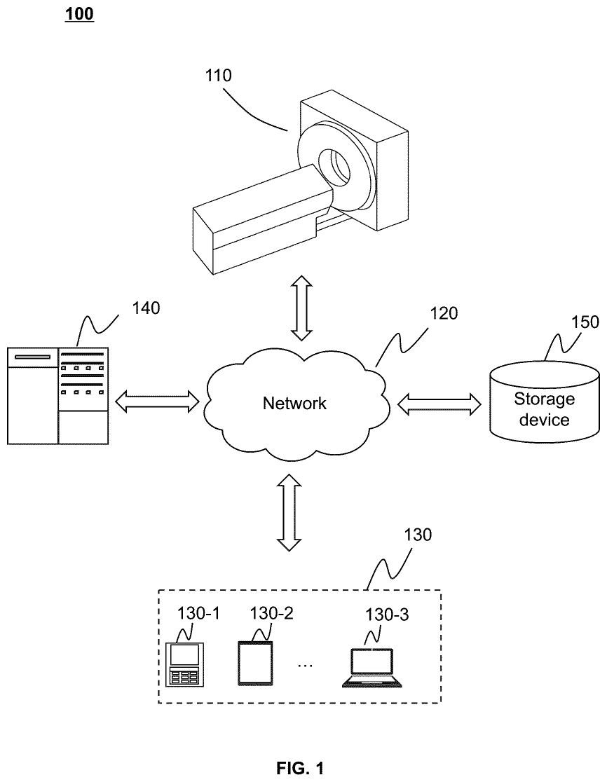

FIG. 1 is a schematic diagram illustrating an exemplary imaging system 100 according to some embodiments of the present disclosure. As shown in FIG. 1, the imaging system 100 may include an imaging device 110, a network 120, one or more terminals 130, a processing device 140, and a storage device 150. In some embodiments, the imaging device 110, the processing device 140, the storage device 150, and/or the terminal(s) 130 may be connected to and/or communicate with each other via a wireless connection (e.g., the network 120), a wired connection, or a combination thereof. The connection between the components in the imaging system 100 may be variable.

The imaging device 110 may be configured to generate or provide image data by scanning a target subject or at least a part of the target subject (e.g., an ROI of the target subject). For example, the imaging device 110 may perform a scan on the target subject to acquire a first medical image and/or a second medical image of the target subject.

In some embodiments, the imaging device 110 may include a single modality imaging device. For example, the imaging device 110 may include a positron emission tomography (PET) device, a single-photon emission computed tomography (SPECT) device, a computed tomography (CT) device, a magnetic resonance imaging (MRI) device, a digital subtraction angiography (DSA) system, an intravascular ultrasound (IVUS) device, an X-ray imaging device, etc. In some embodiments, the imaging device 110 may include a multi-modality imaging device. Exemplary multi-modality imaging devices may include a positron emission tomography-computed tomography (PET-CT) device, a positron emission tomography-magnetic resonance imaging (PET-MRI) device, a single-photon emission computed tomography-computed tomography (SPECT-CT) device, a single photon emission computed tomography-magnetic resonance imaging (SPECT-MRI), etc. The multi-modality scanner may perform multi-modality imaging simultaneously or in sequence. For example, the PET-CT device may generate structural X-ray CT image data and functional PET image data simultaneously or in sequence. The PET-MRI device may generate MRI data and PET data simultaneously or in sequence. It should be noted that the imaging system described below is merely provided for illustration purposes, and is not intended to limit the scope of the present disclosure.

The target subject may include patients or other experimental subjects (e.g., experimental mice or other animals). In some embodiments, the target subject may be a patient or a specific portion, organ, and/or tissue of the patient. For example, the target subject may include the head, the neck, the thorax, the heart, the stomach, a blood vessel, soft tissue, a tumor, nodules, or the like, or any combination thereof. In some embodiments, the target subject may be non-biological. For example, the target subject may include a phantom, a man-made object, ctc. The terms “object” and “subject” are used interchangeably in the present disclosure.

The network 120 may include any suitable network that can facilitate the exchange of information and/or data for the imaging system 100. In some embodiments, one or more components (e.g., the imaging device 110, the terminal 130, the processing device 140, the storage device 150, etc.) of the imaging system 100 may communicate information and/or data with one or more other components of the imaging system 100 via the network 120. For example, the processing device 140 may obtain image data from the imaging device 110 via the network 120. As another example, the processing device 140 may obtain user instructions from the terminal 130 via the network 120. In some embodiments, the network 120 may include one or more network access points.

The terminal(s) 130 may include a mobile device 130-1, a tablet computer 130-2, a laptop computer 130-3, or the like, or any combination thereof. In some embodiments, the mobile device 130-1 may include a smart phone, a smart home device, a wearable device, a virtual reality device, an augmented reality device, or the like, or any combination thereof. In some embodiments, the terminal(s) 130 may be part of the processing device 140.

The processing device 140 may process data and/or information obtained from one or more components (the imaging device 110, the terminal(s) 130, and/or the storage device 150) of the imaging system 100. For example, the processing device 140 may identify a lesion region from a first medical image. As another example, the processing device 140 may determine position information of the lesion region in the target subject based on a lesion distribution image and at least one reference segmentation image. In some embodiments, the processing device 140 may be a single server or a server group. The server group may be centralized or distributed. In some embodiments, the processing device 140 may be local or remote. In some embodiments, the processing device 140 may be implemented on a cloud platform.

In some embodiments, the processing device 140 may be implemented by a computing device. For example, the computing device may include a processor, a storage, an input/output (I/O), and a communication port. The processor may execute computer instructions (e.g., program codes) and perform functions of the processing device 140 in accordance with the techniques described herein. The computer instructions may include, for example, routines, programs, objects, components, data structures, procedures, modules, and functions, which perform particular functions described herein. In some embodiments, the processing device 140, or a portion of the processing device 140 may be implemented by a portion of the terminal 130.

In some embodiments, the processing device 140 may include multiple processing devices. Thus, operations and/or method steps that are performed by one processing device as described in the present disclosure may also be jointly or separately performed by the multiple processing devices. For example, if in the present disclosure, the prompting system 100 executes both operation A and operation B, it should be understood that operation A and operation B may also be performed by two or more different processing devices jointly or separately (e.g., a first processing device executes operation A and a second processing device executes operation B, or the first and second processing devices jointly execute operations A and B).

The storage device 150 may store data/information obtained from the imaging device 110, the terminal(s) 130, and/or any other component of the imaging system 100. In some embodiments, the storage device 150 may include a mass storage, a removable storage, a volatile read-and-write memory, a read-only memory (ROM), or the like, or any combination thereof. In some embodiments, the storage device 150 may store one or more programs and/or instructions to perform exemplary methods described in the present disclosure.

In some embodiments, the imaging system 100 may include one or more additional components and/or one or more components of the imaging system 100 described above may be omitted. Additionally or alternatively, two or more components of the imaging system 100 may be integrated into a single component. A component of the imaging system 100 may be implemented on two or more sub-components.

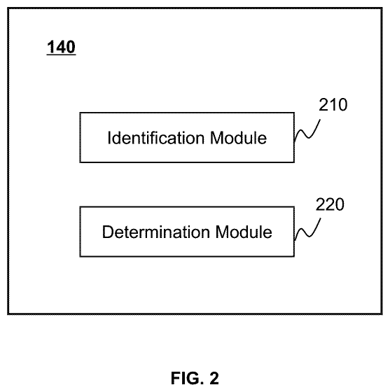

FIG. 2 is a block diagram illustrating an exemplary processing device 140 according to some embodiments of the present disclosure. In some embodiments, the processing device 140 may be in communication with a computer-readable storage medium (e.g., the storage device 150 illustrated in FIG. 1) and the modules of the processing device 140 may execute instructions stored in the computer-readable storage medium.

As illustrated in FIG. 2, the processing device 140 may include an identification module 210 and a determination module 220.

The identification module 210 may be configured to identify a target region corresponding to at least one reference organ from a first medical image of a target subject. The first medical image may refer to a medical image for identifying a lesion region. A reference organ may refer to an organ that can indicate the difference in the metabolism between the target subject and other subject(s). The target region may refer to an image region in the first medical image where the at least one reference organ is located. More descriptions regarding the identification of the target region corresponding to the at least one reference organ may be found elsewhere in the present disclosure. See, e.g., operation 302 and relevant descriptions thereof.

The determination module 220 may be configured to determine, based on the target region, a reference threshold used for lesion detection. The reference threshold may be used to identify the lesion region from the first medical image. More descriptions regarding the determination of the reference threshold may be found elsewhere in the present disclosure. Sec, e.g., operation 304 and relevant descriptions thereof.

In some embodiments, the identification module 210 may be further configured to identify, based on the reference threshold, the lesion region from the first medical image. The lesion region may refer to an image region in the first medical image where at least one lesion is located. More descriptions regarding the identification of the lesion region may be found elsewhere in the present disclosure. See, e.g., operation 306 and relevant descriptions thereof.

It should be noted that the above descriptions of the processing device 140 are provided for the purposes of illustration, and are not intended to limit the scope of the present disclosure. For persons having ordinary skills in the art, various variations and modifications may be conducted under the guidance of the present disclosure. However, those variations and modifications do not depart from the scope of the present disclosure. In some embodiments, the processing device 140 may include one or more other modules. For example, the processing device 140 may include a storage module to store data generated by the modules in the processing device 140. In some embodiments, any two of the modules may be combined as a single module, and any one of the modules may be divided into two or more units.

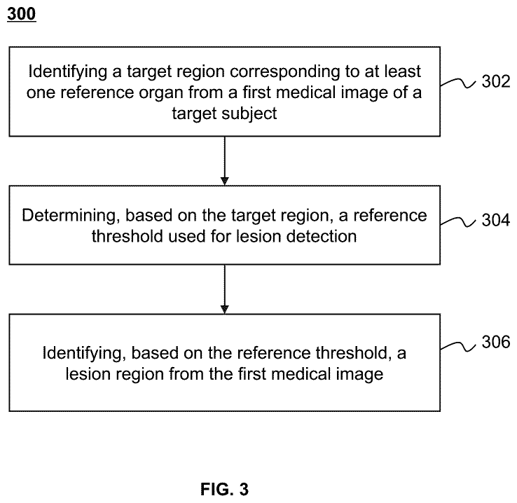

FIG. 3 is a flowchart illustrating an exemplary process 300 for lesion region identification according to some embodiments of the present disclosure. Process 300 may be implemented in the imaging system 100 illustrated in FIG. 1. For example, the process 300 may be stored in the storage device 150 in the form of instructions (e.g., an application), and invoked and/or executed by the processing device 140.

Normally, a medical image of a target subject acquired using medical imaging techniques may be processed for determining the status of the target subject. For example, an ROI (e.g., a lesion region) may be identified by a user (e.g., a doctor, a technician, etc.) or by using an empirical value as a reference threshold. However, such approaches may easily result in a false lesion identification result and have a limited accuracy. In order to improve the accuracy of the lesion region identification, the process 300 may be performed.

In 302, the processing device 140 (e.g., the identification module 210) may identify a target region corresponding to at least one reference organ from a first medical image of a target subject.

The first medical image may refer to a medical image for identifying a lesion region. In some embodiments, the first medical image may be a functional image of the target subject. For example, the first medical image may be a PET image, a SPECT image, etc. In some embodiments, the first medical image may include a two-dimensional (2D) image, a three-dimensional (3D) image (e.g., including a plurality of 2D images (or slices)), a four-dimensional (4D) image (e.g., including a plurality of 3D images captured at a series of time points), etc.

In some embodiments, the first medical image may include standard uptake values (SUVs) of elements in the first medical image. An SUV may refer to a ratio of radioactivity of an uptake of a PET radiotracer taken by a portion of the target subject to mean radioactivity of a total uptake of the PET radiotracer taken by the target subject. An element may refer to a minimum unit of the first medical image corresponding to the target subject that has an SUV. For example, each pixel (or voxel) in the first medical image may have an SUV. In some embodiments, the SUV of the element may indicate an uptake/metabolism of a physical point of the target subject corresponding to the element. For example, the higher the SUV of the element, the higher the uptake of the physical point corresponding to the element. In some embodiments, an SUV of an element may be determined according to Equation (1):

$$S U V = \frac{c}{d / m} , \qquad ( 1 )$$

Where c refers to a radiation concentration of the element; d refers to a total dose of the PET radiotracer; and m refers to a weight of the target subject.

In some embodiments, the processing device 140 may obtain the first medical image from a first imaging device for implementing a first imaging modality (e.g., a PET device, a PET scanner of a multi-modality imaging device, etc.) or a storage device (e.g., the storage device 150, a database, or an external storage) that stores the first medical image of the target subject. In some embodiments, the first medical image may be generated based on first scan data collected using the first imaging modality according to a reconstruction algorithm.

In some embodiments, the processing device 140 may further preprocess the first medical image. Exemplary preprocessing operations may include image transformation, uniformization, image enhancement, image denoising, image segmentation, or the like, or any combination thereof.

A reference organ may refer to an organ that can indicate the difference in the metabolism between the target subject and other subject(s). Exemplary reference organs may include a liver, a lung, a kidney, or the like, or any combination thereof. In some embodiments, the at least one reference organ may be determined based on a system default setting or set manually by a user. For example, if a PET radiotracer corresponding to the first imaging modality is a tracer based on a prostate-specific membrane antigen (PSMA) (e.g., a PSMA marked by 68Ga (68Ga-PSMA), a PSMA marked by 18F (18F-PSMA), etc.), the processing device 140 may automatically determine the liver as the at least one reference organ. As another example, a user may determine the at least one reference organ via a user interface, such as, by selecting at least one option indicating the at least one reference organ, inputting at least one reference organ, etc.

The target region may refer to an image region in the first medical image where the at least one reference organ is located. For example, the target region may be an image region in the first medical image including at least one representation of the at least one reference organ. In some embodiments, the target region may include a 2D image region, a 3D image region, etc.

In some embodiments, the processing device 140 may identify the target region from the first medical image according to a second medical image of the target subject. The second medical image may be acquired using a second imaging modality different from the first imaging modality. For example, the first imaging modality may be PET, and the second imaging modality may be one of CT, MR, and X-ray. Correspondingly, the first medical image may be a PET image, and the second medical image may be one of a CT image, an MR image, and an X-ray image. In some embodiments, the first medical image and the second medical image may provide different information of the target subject. For example, the first medical image may provide more functional information of the target subject than the second medical image, and the second medical image may provide more structural information (or anatomical information) of the target subject than the first medical image.

In some embodiments, the second medical image may be obtained in a similar manner as how the first medical image is obtained as described above. For example, the processing device 140 may obtain the second medical image from an imaging device for implementing the second imaging modality (e.g., a CT device, an MRI scanner of a multi-modality imaging device, etc.) or a storage device (e.g., the storage device 150, a database, or an external storage) that stores the second medical image of the subject. As another example, the processing device 140 may obtain second scan data from the imaging device or the storage device, and generate the second medical image by reconstructing the second scan data. In some embodiments, the first scan data and the second scan data may be collected by two independent scanners or two imaging components of a multi-modality scanner. For example, the first scan data may be collected by a PET scanner, and the second scan data may be collected by a CT scanner. Alternatively, the first scan data may be collected by a PET component of a PET/CT scanner, and the second scan data may be collected by a CT component of a PET/CT scanner.

In some embodiments, the processing device 140 may generate a segmentation image of the at least one reference organ by segmenting the at least one reference organ from the second medical image of the target subject. For example, the processing device 140 may segment the at least one reference organ from the second medical image of the target subject based on a first image segmentation technique to generate the segmentation image of the at least one reference organ. Exemplary image segmentation techniques may include a region-based segmentation, an edge-based segmentation, a wavelet transform segmentation, a mathematical morphology segmentation, a genetic algorithm-based segmentation, or the like, or a combination thereof.

As another example, the processing device 140 may segment the at least one reference organ from the second medical image of the target subject using a reference organ segmentation model (also referred to as a first reference organ segmentation model) to generate the segmentation image of the at least one reference organ. For instance, the processing device 140 may segment the at least one reference organ from the second medical image by inputting the second medical image into the first reference organ segmentation model. Merely by way of example, the processing device 140 may input the second medical image of the target subject into the first reference organ segmentation model, and the first reference organ segmentation model may output the segmentation image of the at least one reference organ or other information (e.g., a segmentation mask of the at least one reference organ) that can be used to segment the at least one reference organ.

In some embodiments, the first reference organ segmentation model may refer to a process or an algorithm used for segmenting the target region based on the second medical image. The first reference organ segmentation model may be a trained machine learning model. Exemplary machine learning models may include a convolutional neural network (CNN) model, a recurrent neural network (RNN) model, a deep residual network (DRN) model, a long short term memory (LSTM) network model, a fully convolutional neural network (FCN) model, a generative adversarial network (GAN) model, a u-net model, a radial basis function (RBF) machine learning model, a DeepMask model, a SegNet model, a dilated convolution model, a conditional random fields as recurrent neural networks (CRFasRNN) model, a pyramid scene parsing network (pspnet) model, or the like, or any combination thereof.

In some embodiments, the processing device 140 may obtain the first reference organ segmentation model from a storage device (e.g., the storage device 150) of the imaging system 100 or a third-party database. In some embodiments, the first reference organ segmentation model may be generated by the processing device 140 or another computing device according to a machine learning algorithm. In some embodiments, the first reference organ segmentation model may be generated by training a first initial model using a plurality of first training samples. Each of the plurality of first training samples may include a sample second medical image of a sample subject and a sample segmentation image of the at least one reference organ of the sample subject. The sample second medical image of a first training sample may be obtained using the second imaging modality. The sample segmentation image may be confirmed or labelled manually by a user and used as a training label.

In some embodiments, the processing device 140 may identify the target region from the first medical image based on the segmentation image. For example, the processing device 140 may register the first medical image with the segmentation image, and identify the target region from the registered first medical image based on position information of the at least one reference organ in the segmentation image. Since the second medical image provides more structural information (or anatomical information) of the target subject than the first medical image, the segmentation of the at least one reference organ from the second medical image may have a higher precision than the identification of the target region from the first medical image, which improves the accuracy of the identification of the target region.

In some embodiments, the processing device 140 may directly identify the target region from the first medical image. For example, the processing device 140 may identify the target region from the first medical image based on a second image segmentation technique. The second image segmentation technique may be the same as or different from the first image segmentation technique.

As another example, the processing device 140 may identify the target region from the first medical image using a reference organ segmentation model (also referred to as a second reference organ segmentation model). For instance, the processing device 140 may identify the target region from the first medical image by inputting the first medical image into the second reference organ segmentation model. The second reference organ segmentation model may output a segmentation image indicating the target region of the at least one reference organ or other information (e.g., position and/or size information) that can be used to identify the target region.

In some embodiments, the second reference organ segmentation model may refer to a process or an algorithm used for segmenting the target region based on the first medical image. The second reference organ segmentation model may be a trained machine learning model.

In some embodiments, the second reference organ segmentation model may be obtained in a similar manner as how the first reference organ segmentation model is obtained as described above. In some embodiments, the second reference organ segmentation model may be generated by a computing device (e.g., the processing device 140) by training a second initial model using a plurality of second training samples. The second initial model may be the same as or different from the first initial model. Each of the plurality of second training samples may include a sample first medical image of a sample subject and a sample region of the sample subject. The sample first medical image of a second training sample may be obtained using the first imaging modality. The sample region may be a region corresponding to the at least one reference organ in the sample first medial image, which may be confirmed or labelled manually by a user and used as a training label. In some embodiments, each of the plurality of second training samples may further include other sample information (e.g., a sample segmentation mask of the sample region).

In 304, the processing device 140 (e.g., the determination module 220) may determine, based on the target region, a reference threshold used for lesion detection.

The reference threshold may be used to identify the lesion region from the first medical image. For example, the reference threshold may be an SUV threshold. For instance, if an SUV of an element in the first medical image exceeds the SUV threshold, the element may be identified as a portion of the lesion region. Alternatively, if the SUV of the element of the first medical image does not exceed the SUV threshold, the element may not be identified as a portion of the lesion region. In some embodiments, the reference threshold may include one or more threshold values (e.g., a minimum value, a maximum value) and/or a value range.

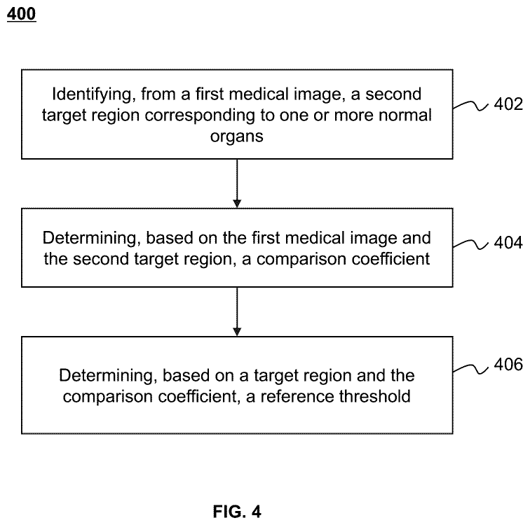

In some embodiments, the processing device 140 may determine the reference threshold based on the target region. For example, the processing device 140 may identify a second target region corresponding to one or more normal organs from the first medical image, determine a comparison coefficient based on the first medical image and the second target region, and determine the reference threshold based on the target region and the comparison coefficient. More descriptions regarding the determination of the reference threshold may be found elsewhere in the present disclosure. See, e.g., FIG. 4 and relevant descriptions thereof.

In 306, the processing device 140 (e.g., the identification module 210) may identify, based on the reference threshold, the lesion region from the first medical image.

The lesion region may refer to an image region in the first medical image where at least one lesion is located. For example, the lesion region may be an image region of the first medical image including at least one representation of the at least one lesion. Exemplary lesions may include a tumor, a cancer-ridden organ, inflammation, or the like, or any combination thereof.

In some embodiments, the processing device 140 may identify, based on the reference threshold, the lesion region from the first medical image using an image identification technique. For example, the processing device 140 may determine target elements whose SUVs exceed the SUV threshold. Further, the processing device 140 may designate the region including the target elements as the lesion region.

In some embodiments, the processing device 140 may check the target elements before designating the region including the target elements as the lesion region. For example, for each of the target elements, the processing device 140 may determine whether the target element is connected to other target element(s). If the target element is not connected to other target element(s), the processing device 140 may delete the target element or send the determination result to a user terminal for manual determination. As another example, for a set of connected target elements (i.e., target elements forming a connected region), the processing device 140 may determine whether a count of the connected target elements exceeds a count threshold or an area of the connected target elements exceeds an area threshold. If the count of the connected target elements does not exceed the count threshold or the area of the connected target elements does not exceed the area threshold, the processing device 140 may delete the set of connected target elements or send the determination result to a user terminal for manual determination. The count threshold or the area threshold may be determined based on a system default setting or set manually by a user.

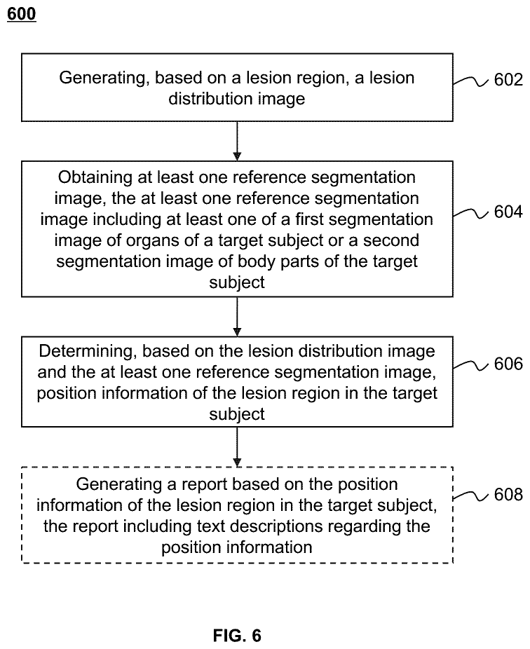

In some embodiments, the processing device 140 may generate, based on the lesion region, a lesion distribution image. The lesion distribution image may indicate the distribution of the lesion region in the target subject and be used to determine the position information of the lesion region in the target subject. More descriptions regarding the generation of the lesion distribution image may be found in elsewhere in the present disclosure (e.g., FIG. 6 and the descriptions thereof).

According to some embodiments of the present disclosure, the reference threshold used for lesion detection may be automatically determined based on the target region corresponding to the at least one reference organ in the first medical image, which is insusceptible to human error or subjectivity, reduces time and/or labor consumption, and improves the accuracy and efficiency of the reference threshold determination. In addition, the lesion region may be identified from the first medical image based on the reference threshold, which improves the accuracy of the lesion region identification.

FIG. 4 is a flowchart illustrating an exemplary process 400 for determining a reference threshold according to some embodiments of the present disclosure. In some embodiments, the process 400 may be performed to achieve at least part of operation 304 as described in connection with FIG. 3.

In 402, the processing device 140 (e.g., the determination module 220) may identify, from a first medical image, a second target region corresponding to one or more normal organs.

A normal organ may refer to an organ without lesion. In some embodiments, the normal organ can not be imaged or can be imaged at a relatively low level when a PET radiotracer is injected into a target subject. Therefore, the one or more normal organs may be determined based on the PET radiotracer injected into the target subject in the PET scan for acquiring the first medical image. Merely by way of example, if the PET radiotracer is a tracer based on PSMA (e.g., 68Ga-PSMA, 18F-PSMA, etc.), the processing device 140 may determine the kidney of the target subject as the one or more normal organs.

In some embodiments, a disease stage of the target subject may be considered in determining the one or more normal organs. In some occasions, the disease of the target subject may have multiple disease stages, and the lesion region may be distributed in different regions in the target subject in different disease stages. For example, if the lesion is a tumor, the tumor may be distributed in different regions (e.g., possible abnormal organs) of the target subject in different tumor stages. Merely by way of example, according to a tumor-node-metastasis (TNM) staging criteria, the T-stage tumor may be located at a primary site, the N-stage tumor may be metastasized to lymph, and the M-stage tumor may be metastasized to a distal end. Possible distributions of different tumors in different disease stages may be determined according to the TNM staging criteria.

Merely by way of example, the processing device 140 may determine the disease stage of the target subject. For example, the disease stage of the target subject may be determined based on a diagnostic record of the target subject or input by a user (e.g., a doctor). The processing device 140 may determine the one or more possible abnormal organs of the target subject based on the disease stage. For example, if the lesion is a tumor, the processing device 140 may determine one or more possible abnormal organs of the target subject based on the disease stage and the TNM staging criteria. Further, the processing device 140 may determine, based on the one or more possible abnormal organs, the one or more normal organs. For example, the processing device 140 may determine one or more remaining organs other than the one or more possible abnormal organs, and designate the remaining organ(s) as the one or more normal organs.

The second target region may refer to an image region in the first medical image where the one or more normal organs are located. For example, the second target region may be an image region of the first medical image including one or more representations of the one or more normal organs.

In some embodiments, the processing device 140 may identify, from the first medical image, the second target region corresponding to one or more normal organs. The second target region may be identified in a similar manner as how the target region is identified as described in FIG. 3. For example, the processing device 140 may directly identify the second target region from the first medical image based on, such as, an image segmentation technique, a segmentation model, etc. As another example, the processing device 140 may identify the second target region from the first medical image based on a second medical image of the target subject.

In 404, the processing device 140 (e.g., the determination module 220) may determine, based on the first medical image and the second target region, a comparison coefficient.

The comparison coefficient may reflect differences between different regions of the first medical image. For example, the comparison coefficient may reflect the difference in the metabolism between a remaining region of the first medical image and the first medical image. The remaining region of the first medical image may refer to an image region of the first medical image determined by removing the second target region from the first medical image. In some embodiments, the comparison coefficient may be a ratio of a first mean value of SUVs to a second mean value of SUVs. As used herein, the first mean value of the SUVs may refer to a mean value of the SUVs of elements in the remaining region of the first medical image. The second mean value of the SUVs may refer to a mean value of the SUVs of the elements in the first medical image. Merely by way of example, the processing device 140 may determine the remaining region of the first medical image based on the first medical image and the second target region, and determine the first mean value of SUVs of the elements in the remaining region of the first medical image and the second mean value of SUVs of the elements in the first medical image. Further, the processing device 140 may determine the comparison coefficient based on the first mean value and the second mean value.

In 406, the processing device 140 (e.g., the determination module 220) may determine, based on the target region and the comparison coefficient, a reference threshold.

In some embodiments, the processing device 140 may obtain SUVs of the elements in the target region. Accordingly, the processing device 140 may determine a mean value (also referred to as a third mean value) and a standard variance value of the SUVs of the elements in the target region.

The processing device 140 may further determine the reference threshold based on the third mean value, the standard variance value, and the comparison coefficient. For example, the reference threshold may be determined according to Equation (2):

$$threshold = weight \times ( S U {V}_{m e a n} + n S U {V}_{S D} ) , \qquad ( 2 )$$

where threshold refers to the reference threshold; weight refers to the comparison coefficient; SUVₘₑₐₙ refers to the third mean value; SUV_{SD} refers to the standard variance value; and n refers to an adjustment coefficient.

In some embodiments, the adjustment coefficient may be determined based on the target subject (e.g., a predicted lesion of the target subject) and/or the PET radiotracer. For example, a corresponding relationship between a plurality of candidate adjustment coefficients and a plurality of reference lesions and/or a plurality of reference PET radiotracers may be pre-established. The processing device 140 may determine the adjustment coefficient based on the corresponding relationship and the predicted lesion of the target subject and/or the PET radiotracer. Merely by way of example, when the PET radiotracer is a tracer based on PSMA (e.g., 68Ga-PSMA, 18F-PSMA, etc.), and the predicted lesion of the target subject is prostatic cancer (PCa), the adjustment coefficient may be determined as 3.

In some embodiments, the processing device 140 may adjust the adjustment coefficient based on the result of the lesion region identification. For example, if an area of the identified lesion region is not within a value range, the processing device 140 may adjust the adjustment coefficient. For instance, if the area of the identified lesion region is larger than the maximum value in the value range (which indicates too much lesion region is identified), the processing device 140 may increase the adjustment coefficient. If the area of the identified lesion region is smaller than the minimum value in the value range (which indicates too little lesion region is identified), the processing device 140 may decrease the adjustment coefficient.

According to some embodiments of the present disclosure, by introducing the adjustment coefficient and the comparison coefficient, the reference threshold may be determined individually with respect to the target subject, which may improve the accuracy of the reference threshold determination, thereby improving the accuracy of the lesion region identification. At the same time, the third mean value (SUVₘₑₐₙ) and the standard variance value (SUV_{SD}) may be determined based on the target region corresponding to the at least one reference organ, while the at least one reference organ can indicate the metabolism of the target subject. Therefore, when the reference threshold is determined, the metabolism of the target subject may be considered to reduce or eliminate the effect of the difference in the metabolism between the target subject and other subject(s) on the accuracy of the reference threshold determination. In addition, the comparison coefficient may be determined by removing the second target region, the effect of the one or more normal organs may be eliminated, which further improves the accuracy of the reference threshold determination.

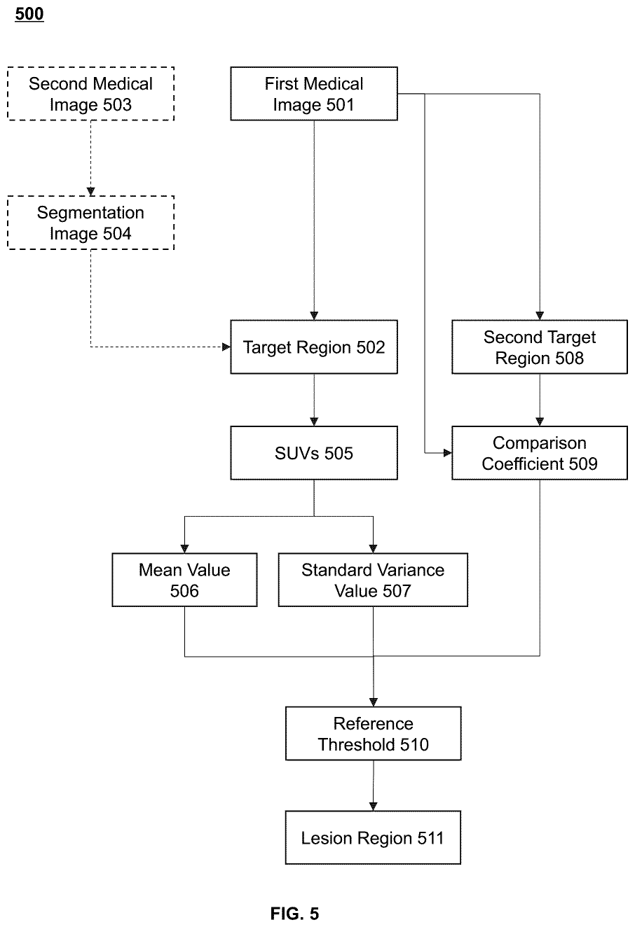

FIG. 5 is a schematic diagram illustrating an exemplary process 500 for lesion region identification according to some embodiments of the present disclosure.

As illustrated in FIG. 5, a target region 502 corresponding to at least one reference organ may be directly identified from a first medical image 501 (e.g., a PET image) of a target subject. Alternatively, a segmentation image 504 of the at least one reference organ may be generated by segmenting the at least one reference organ from a second medical image 503 (e.g., a CT image) of the target subject, and the target region 502 may be identified from the first medical image 501 based on the segmentation image 504. SUVs 505 of elements in the target region 502 may be obtained, and then a mean value 506 and a standard variance value 507 of the SUVs 505 may be determined. A second target region 508 may be identified from the first medical image 501, and a comparison coefficient 509 may be determined based on the first medical image 501 and the second target region 508. A reference threshold 510 may be determined based on the mean value 506, the standard variance value 507, and the comparison coefficient 509. Further, a lesion region 511 may be identified from the first medical image 501 based on the reference threshold 510.

FIG. 6 is a flowchart illustrating an exemplary process 600 for determining position information of a lesion region according to some embodiments of the present disclosure. In some embodiments, the process 600 may be performed after the process 300.

At present, after a lesion region is identified from a medical image, position information (e.g., which organ or body part that the lesion region belongs to) needs to be determined by a user, which is inefficient and susceptible to human errors. In order to improve the efficiency and accuracy of the position information determination, the process 600 may be performed.

In 602, the processing device 140 (e.g., the determination module 220) may generate, based on a lesion region, a lesion distribution image.

The lesion distribution image may refer to an image reflecting the position distribution of lesions in a target subject. For example, the lesion distribution image may be a medical image of the target subject marked with the lesion region. For instance, the lesion distribution image may be a lung image in which a lesion region in the lungs is marked. In some embodiments, the lesion distribution image may be a PET image, a CT image, etc., marked with the lesion region.

In some embodiments, the processing device 140 may identify the lesion region from a fourth medical image. The fourth medical image may be a PET image, a CT image, etc., and the fourth medical image may be obtained in a similar as how the first medical image and/or the second medical image are obtained as described in FIG. 3. For example, the fourth medical image may be the first medical image (e.g., a PET image), and the lesion region may be identified in a similar as how the lesion region is identified as described in FIG. 3. As another example, the lesion region may be identified using a lesion region identification model.

In some embodiments, the lesion region identification model may refer to a process or an algorithm used for identifying the lesion region based on the fourth medical image. The lesion region identification model may be a trained machine learning model.

In some embodiments, the lesion region identification model may be obtained in a similar manner as how the reference organ segmentation model (e.g., the first reference organ segmentation model and/or the second reference organ segmentation model) is obtained as described above. For example, the lesion region identification model may be generated by training a third initial model using a plurality of third training samples. Each of the plurality of third training samples may include a sample third medical image of a sample subject and a sample lesion region of the sample subject. The sample fourth medical image of a third training sample may be obtained using a first imaging modality or a second imaging modality. The sample lesion region may be confirmed or labelled manually by a user and used as a training label.

In some embodiments, the processing device 140 may generate the lesion distribution image by labelling the lesion region on the fourth medical image. For example, the processing device 140 may highlight the lesion region to generate the lesion distribution image. As another example, the processing device 140 may cover the lesion region using a highlighted color to generate the lesion distribution image. As yet another example, the processing device 140 may mark the lesion region by depicting the boundary of the lesion region in the fourth medical image.

In some embodiments, the processing device 140 may preprocess the lesion distribution image. Exemplary preprocessing operations may include image transformation, uniformization, image enhancement, image denoising, image segmentation, filtering, grayscale binarization, or the like, or any combination thereof.

In 604, the processing device 140 (e.g., the determination module 220) may obtain at least one reference segmentation image. The at least one reference segmentation image may include at least one of a first segmentation image of organs of the target subject or a second segmentation image of body parts of the target subject.

The reference segmentation image may refer to a segmentation image of a specific structure of the target subject that is used to register the lesion distribution image. For example, the reference segmentation image and the lesion distribution image may be aligned with each other to determine which organ or body part the lesion of the target subject is located in. As used herein, the first segmentation image may be an image segmented at an organ level. For example, the first segmentation image may be an image marked with a plurality of organs (e.g., the lung, the kidney, etc.) of the target subject. The second segmented image may be an image segmented at a body part level. For example, the second segmented image may be an image marked with a plurality of body parts (e.g., a neck part, an abdomen part, a chest part, etc.) of the target subject.

In some embodiments, the processing device 140 may generate the first segmentation image by segmenting the organs of the target subject from a second medical image of the target subject. For example, the processing device 140 may segment the organs of the target subject from a CT image based on CT values of the organs of the target subject to generate the first segmentation image. Since different organs correspond to different CT values, the organs of the target subject may be segmented from the CT image based on the CT values of the organs. Accordingly, the CT image may be segmented into different regions corresponding to the different organs, such as, a first region corresponding to the liver (e.g., a liver segmentation), a second region corresponding to the kidney, a third region corresponding to the lung (e.g., a lung lobe), a fourth region corresponding to the ribs (e.g., a first rib, a second rib, etc.), a fifth region corresponding to the vertebrae (e.g., a first vertebrae, a second vertebrae, etc.), etc. As another example, the processing device 140 may segment the organs of the target subject from an MR image based on MR signals of the organs of the target subject to generate the first segmentation image.

In some embodiments, the processing device 140 may generate the second segmentation image by segmenting the body parts of the target subject from a third medical image of the target subject.

The third medical image may be a scout image of the target subject. The scout image may refer to an image used to preliminarily determine a range of the lesion. For example, the scout image may reflect overall information of the target subject. Exemplary scout images may include a coronal image, a sagittal image, etc., of the target subject.

In some embodiments, the scout image may include a positioning frame. The positioning frame may be used to mark a part of the target subject within an FOV of subsequent scans (e.g., a PET scan, a CT scan). Therefore, the scout image may be used for body part segmentation. In addition, the scout image may include scanning information, such as, a scanning time, a scanning range, a scanning angel, a scanning parameter, a delay time, etc., which can be used to determine a scanning plan to improve the accuracy of the imaging. Therefore, the body parts of the target subject may be segmented from the scout image. For example, the scout image may be divided into a head part, a neck part, a chest part, an abdomen part, a leg part, etc., of the target subject.

In some embodiments, the third medical image may be acquired before acquiring the second medical image. An imaging modality of the third medical image may include a CT imaging modality, an MR imaging modality, a depth camera imaging, etc.

In some embodiments, the processing device 140 may segment the body parts of the target subject from the third medical image of the target subject according to an image segmentation technique or a segmentation model. For example, the third medical image may be segmented using an image semantic segmentation model. The image semantic segmentation model may be a trained machine learning model. Exemplary image semantic segmentation models may include an FCN model, a u-net model, etc.

In some embodiments, the processing device 140 may preprocess the first segmentation image and/or the second segmentation image. Exemplary preprocessing operations may include image transformation, uniformization, image enhancement, image denoising, image segmentation, filtering, grayscale binarization, or the like, or any combination thereof.

In 606, the processing device 140 (e.g., the determination module 220) may determine, based on the lesion distribution image and the at least one reference segmentation image, position information of the lesion region in the target subject.

The position information of the lesion region may indicate where the lesion region is located in the target subject. For example, the position information may include a specific organ and/or a body part where the lesion is located, a position where the lesion is located at the specific organ and/or the specific body part. For instance, the position information may indicate that the lesion region is located at the left lung of the chest part. As another example, the position information may include a location (e.g., coordinates), a contour, a shape, a height, a width, a thickness, an area, a volume, a ratio of height to width, or the like, or any combination thereof, of the lesion region in the target subject. Merely by way of example, the position information may include coordinates of one or more feature points (e.g., boundary points, a central point, a center of gravity) of the lesion region.

In some embodiments, the at least one reference segmentation image may include the first segmentation image and the second segmentation image. The processing device 140 may determine the position information of the lesion region in the target subject based on the lesion distribution image, the first segmentation image, and the second segmentation image. For example, the processing device 140 may generate a fusion image by fusing the first segmentation image and the second segmentation image, generate a registered image by registering the fusion image and the lesion distribution image, and determine the position information of the lesion region in the target subject based on the registered image.

In some embodiments, the at least one reference segmentation image may include the first segmentation image. The processing device 140 may determine the position information of the lesion region in the target subject based on the lesion distribution image and the first segmentation image. For example, the processing device 140 may generate a registered first segmentation image by registering the first segmentation image and the lesion distribution image, generate a first fusion image by fusing the registered first segmentation image and the lesion distribution image, and determine the position information of the lesion region in the target subject based on the first fusion image.

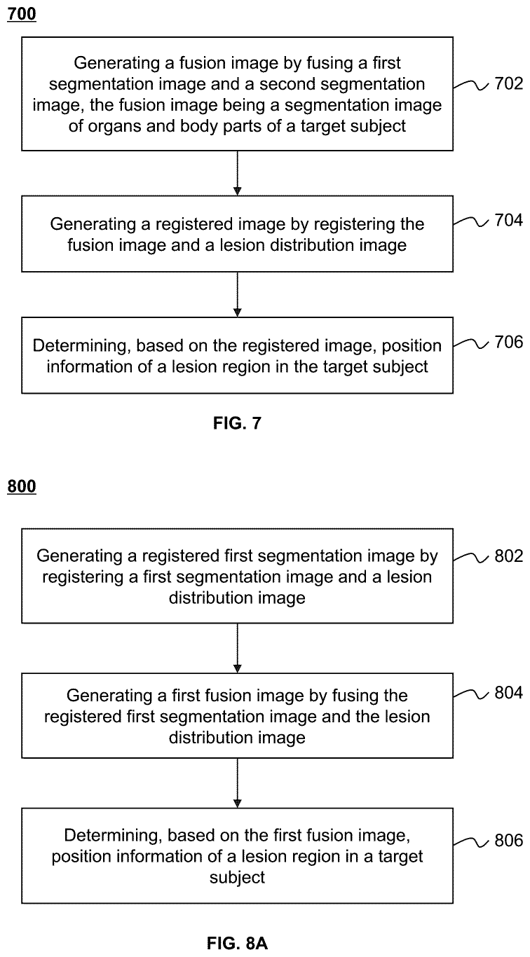

In some embodiments, the at least one reference segmentation image may include the second segmentation image. The processing device 140 may determine the position information of the lesion region in the target subject based on the lesion distribution image and the second segmentation image. For example, the processing device 140 may generate a registered second segmentation image by registering the second segmentation image and the lesion distribution image, generate a second fusion image by fusing the registered second segmentation image and the lesion distribution image, and determine the position information of the lesion region in the target subject based on the second fusion image. More descriptions regarding the determination of the position information of the lesion region may be found in elsewhere in the present disclosure (e.g., FIGS. 7-9 and the descriptions thereof).

In some embodiments, before the at least one reference segmentation image (e.g., the fusion image, the first segmentation image, the second segmentation image) is registered with the lesion distribution image, the processing device 140 may determine whether a first field of view (FOV) of the lesion distribution image is the same as a second FOV of the at least one reference segmentation image. If the first FOV is different from the second FOV, the processing device 140 may process the at least one reference segmentation image or the lesion distribution image. For example, if the first FOV is 700 nm that can cover the whole target subject, the second FOV is 500 nm that can not cover arm(s) of the target subject, and part of the target subject is located out of the second FOV, the processing device 140 may generate a reconstruction image of a region out of the second FOV corresponding to at least one reference segmentation image using an FOV extension algorithm. As another example, if the first FOV is within a range from a head part to a knee part, and the second FOV is within a range from a head part to a thigh part, and the ROI (e.g., a lesion region) is located out of the second FOV, the processing device 140 may predict the organ or body part where the ROI is located using a positioning algorithm.

In some embodiments, for a large organ (e.g., the liver) whose area is larger than a second area threshold, the processing device 140 may determine the position information of the lesion region in the target subject based on the lesion distribution image. The second area threshold may be determined based on a system default setting or set manually by a user.

In 608, the processing device 140 (e.g., the determination module 220) may generate a report based on the position information of the lesion region in the target subject.

The report may include text descriptions regarding the position information. For example, for a lesion A, the processing device 140 may generate a report including text descriptions, such as, “the lesion A is located in the upper lobe of the left lung, the SUV value is 3, and the volume is 3 mm×3 mm×2 mm.” In some embodiments, when the lesion region includes a plurality of lesions, the processing device 140 may generate a report including text descriptions for each lesion.

In some embodiments, the report may also include image descriptions regarding the position information. For example, the report may include the text descriptions and one or more images generated during the lesion region identification process (e.g., the lesion distribution image, the first segmentation image, the second segmentation image, etc.).

In some embodiments, the report may further include diagnostic information. The diagnostic information may include information, such as a size, a position, a severity degree, a shape, an ingredient, or the like, or any combination thereof, of the lesion region. Merely by way of example, the lesion region may be a tumor, and the diagnostic information of the lesion region may include a size, a volume, a position, a severity degree, a stage, a type (e.g., benign or malignant), etc., of the tumor.

In some embodiments, the processing device 140 may generate the report based on a report template. The report template may be preset based on a system default setting or set manually by a user. In some embodiments, the report template may include various items, such as, position information, a SUV, a volume, diagnosis information, etc., of the lesion. The processing device 140 may fill the report template using the position information to generate the report.

According to some embodiments of the present disclosure, the lesion region may be automatically positioned to a specific organ/body part. That is, the position information of the lesion region may be automatically determined, which reduces the labor consumption and the dependence on the experience of the user, and improves the efficiency and accuracy of the lesion region identification. In addition, the report of the lesion region may be automatically generated, which intuitively reflects the condition of the lesion and reduces the labor consumption, thereby improving the efficiency of the lesion region identification and subsequent diagnosis.

FIG. 7 is a flowchart illustrating an exemplary process 700 for determining position information of a lesion region according to some embodiments of the present disclosure. In some embodiments, the process 700 may be performed to achieve at least part of operation 606 as described in connection with FIG. 6.

In 702, the processing device 140 (e.g., the determination module 220) may generate a fusion image by fusing a first segmentation image and a second segmentation image. The fusion image may be a segmentation image of organs and body parts of a target subject.

In some embodiments, the processing device 140 may register the first segmentation image and the second segmentation image. Since the first segmentation image and the second segmentation image are collected using different imaging modalities, a first spatial position of the target subject in the first segmentation image may be different from a second spatial position of the target subject in the second segmentation image. Therefore, the processing device 140 may register the first segmentation image and the second segmentation image to align the first spatial position with the second spatial position.

Merely by way of example, the processing device 140 may generate a registered first segmentation image by registering the first segmentation image with the second segmentation image, and generate the fusion image by fusing the registered first segmentation image and the second segmentation image. As another example, the processing device 140 may generate a registered second segmentation image by registering the second segmentation image with the first segmentation image, and generate the fusion image by fusing the first segmentation image and the registered second segmentation image. As still another example, the processing device 140 may generate a registered first segmentation image and a registered second segmentation image by registering the first segmentation image and the second segmentation image with a reference image (e.g., the first medical image, the second medical image) of the target subject, respectively, and generate the fusion image by fusing the registered first segmentation image and the registered second segmentation image.

In 704, the processing device 140 (e.g., the determination module 220) may generate a registered image by registering the fusion image and the lesion distribution image.

The registered image may be a lesion distribution image marked with the organs and the body parts of the target subject. That is, the registered image may include information of the fusion image and information of the lesion distribution image.

In some embodiments, the processing device 140 may register the fusion image and the lesion distribution image in a same coordinate system. For example, the processing device 140 may transform image data of the fusion image into a coordinate system corresponding to the lesion distribution image, and then register the transformed image data of the fusion image and the lesion distribution image. As another example, the processing device 140 may transform image data of the lesion distribution image into a coordinate system corresponding to the fusion image, and then register the transformed image data of the lesion distribution image and the fusion image. As still another example, the processing device 140 may register the fusion image and the lesion distribution image according to a registration algorithm, such as, a B-spline registration algorithm. For instance, the processing device 140 may obtain multiple organ masks by performing organ segmentation on the fusion image and the lesion distribution image, such as, using a machine learning model. A deformation field may be obtained by processing the multiple organ masks according to a semi-supervised B-spline registration algorithm. Finally, the fusion image and the lesion distribution image may be registered based on the obtained deformation field.

For illustration purposes, the registration of the fusion image and the lesion distribution image in a first imaging coordinate system corresponding to the lesion distribution image may be taken as an example.

The processing device 140 may generate a preliminary point cloud model representing the target subject based on the fusion image. For example, the processing device 140 may preprocess the fusion image to obtain a set of voxels representing the target subject. For instance, the processing device 140 may perform a grayscale binarization and/or a contour extraction on the fusion image to obtain the group of voxels representing the target subject. Merely by way of example, the processing device 140 may perform the contour extraction on the fusion image using an image gradient algorithm to obtain the set of voxels representing the target subject. Each voxel may include second imaging coordinates in a second imaging coordinate system corresponding to the target subject in the fusion image.

The processing device 140 may determine second spatial coordinates of each voxel in a second physical coordinate system according to the second imaging coordinates of each voxel and label data of the fusion image. The second physical coordinate system may refer to a coordinate system established based on an imaging device (e.g., the imaging device 110) that is used to collect scan data corresponding to the fusion image. For example, if scan data corresponding to the first segmentation image and scan data corresponding to the second segmentation image are collected by a same imaging device (e.g., a CT device), the second physical coordinate system may be established based on the imaging device. As another example, if scan data corresponding to the first segmentation image and scan data corresponding to the second segmentation image are collected by different imaging devices (e.g., a CT device and an MR device), the second physical coordinate system may be established based on any one of the different imaging devices. Preferably, the second physical coordinate system may be established based on the imaging device corresponding to the first segmentation image.

In some embodiments, the processing device 140 may generate the preliminary point cloud model based on the second medical image (e.g., a CT image). Correspondingly, the second physical coordinate system may be established based on the imaging device corresponding to the second medical image (e.g., an imaging device for implementing a second imaging modality).

In some embodiments, the fusion image may be stored in a digital imaging and communications in medicine (DICOM) format. The DICOM data may include the label data that is used to transform the second imaging coordinates of each voxel to the second spatial coordinates of each voxel in the second physical coordinate system. For example, the label data may include a first label, a second label, and a third label. As used herein, the second label may indicate spatial coordinates corresponding to an upper left corner of the fusion image in a target subject coordinate system. The third label may indicate a cosine value of an angle between each axis of the second imaging coordinate system and a corresponding axis of the target subject coordinate system. The third label may include six parameters, wherein three parameters may be cosine values of angles between an X-axis of the second imaging coordinate system and three axes of the target subject coordinate system, and the other three parameters may be cosine values of angles between a Y-axis of the second imaging coordinate system and three axes of the target subject coordinate system. If each value of the six parameters is one of 0, 1, and −1, the fusion image may be parallel to a coordinate plane of the target subject coordinate system. If a value of the six parameters is a decimal, the fusion image may have an angel with a coordinate plane of the target subject coordinate system. The first label may indicate a position of the target subject with respect to the imaging device that is used to collect the scan data corresponding to the fusion image, such as, the imaging device used to collect the scan data corresponding to the first segmentation image, the imaging device used to collect the scan data corresponding to the second segmentation image. For example, the first label may be used to describe the positioning of the target subject and a moving mode of a bed of the imaging device that is used to collect the scan data corresponding to the fusion image. The first label may provide a transformation relationship between the target subject coordinate system and the second physical coordinate system. Through the three labels, the second imaging coordinates of each voxel of the fusion image may be transformed to the second spatial coordinates of each voxel in the second physical coordinate system. Further, the preliminary point cloud model may be generated based on the second spatial coordinates of each voxel in the second physical coordinate system.

The processing device 140 may generate a target point cloud model by transforming the preliminary point cloud model. The target point cloud model may correspond to a first physical coordinate system. The first physical coordinate system may refer to a coordinate system established based on an imaging device (e.g., the imaging device 110) that is used to collect scan data corresponding to the lesion distribution image or the fourth medical image (e.g., a PET image). In some embodiments, a transformation relationship between the first physical coordinate system and the second physical coordinate system may be obtained from a storage device that stores the transformation relationship. For example, the transformation relationship may be predetermined by correcting the first physical coordinate system and the second physical coordinate system using a phantom, and stored in a storage device. The processing device 140 may obtain the transformation relationship from the storage device. Merely by way of example, the transformation relationship may be determined according to Equation (3):

$${X}_{1} = R \times {X}_{2} + T , \qquad ( 3 )$$

Where X₁ refers to first spatial coordinates of a voxel in the first physical coordinate system; X₂ refers to second spatial coordinates of a voxel in the second physical coordinate system; R refers to a rotation matrix between the first physical coordinate system and the second physical coordinate system; and T refers to a translation matrix between the first physical coordinate system and the second physical coordinate system.

For example, second spatial coordinates (x₁, y₁, z₁) of each voxel of the fusion image in the second physical coordinate system may be transformed into first spatial coordinates (x₂, y₂, z₂) of each voxel in the first physical coordinate system, and the target point cloud model may include a point in the first physical coordinate system having the first spatial coordinates (x₂, y₂, z₂) corresponding to each voxel of the fusion image.

The processing device 140 may generate a transformation image by transforming the fusion image based on the target point cloud model. For example, the processing device 140 may transform second spatial coordinates of each voxel of the fusion image in the second physical coordinate system into first imaging coordinates of each voxel in the first imaging coordinate system based on the target point cloud model to generate the transformation image.

The processing device 140 may generate the registered image by fusing the transformation image and the lesion distribution image. Since the transformation image can be regarded as a transformed fusion image in the first imaging coordinate system corresponding to the lesion distribution image (e.g., the PET imaging coordinate system), that is, the transformation image corresponds to the same coordinate system as the lesion distribution image, it can be fused with the lesion distribution image directly. The registered image may be regarded as a lesion distribution image marked with the organs and the body parts.

In 706, the processing device 140 (e.g., the determination module 220) may determine, based on the registered image, position information of a lesion region in the target subject.

For example, the position information of the lesion region may be determined by determining which organ or body part the lesion region is located based on the registered image.

According to some embodiments of the present disclosure, the first segmentation image and the second segmentation image may be fused to generate the fusion image, and the registered image may be generated by registering the fusion image and the lesion distribution image, which may realize simultaneously determining the organ and the body part corresponding to the lesion region, and improve the accuracy of the position information determination. In addition, the registration process may be automatically performed, which improves the efficiency and accuracy of the registration.

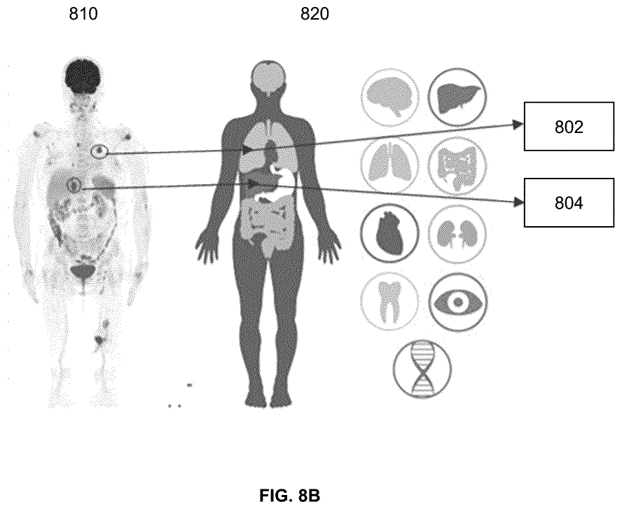

FIG. 8A is a schematic diagram illustrating an exemplary process 800 for determining position information of a lesion region according to some embodiments of the present disclosure. In some embodiments, the process 800 may be performed to achieve at least part of operation 604 as described in connection with FIG. 3.

In 802, the processing device 140 (e.g., the determination module 220) may generate a registered first segmentation image by registering a first segmentation image and a lesion distribution image. The registered first segmentation image may be generated in a similar manner as how the registered image is generated as described in FIG. 7.

In 804, the processing device 140 (e.g., the determination module 220) may generate a first fusion image by fusing the registered first segmentation image and the lesion distribution image. The first fusion image may be a lesion distribution image marked with organs of the target subject. That is, the first fusion image may include information of the first segmentation image and information of the lesion distribution image. The first fusion image may be generated in a similar manner as how the fusion image is generated as described in FIG. 7.

In 806, the processing device 140 (e.g., the determination module 220) may determine, based on the first fusion image, position information of a lesion region in the target subject.

The position information determined based on the first fusion image may indicate which organ the lesion region is located at. For example, as illustrated in FIG. 8B, an image 810 is a lesion distribution image, and an image 820 is a first segmentation image. By registering the image 810 and the image 820 and generating a first fusion image, a first lesion region 802 in the image 810 may be determined as being located at a lung, and a second lesion region 804 in the image 810 may be determined as being located at a liver.

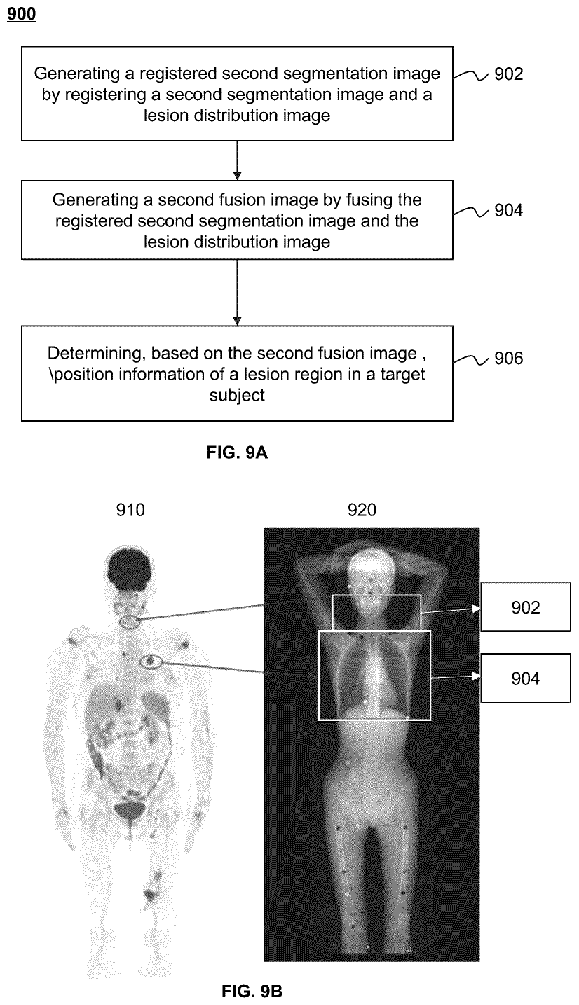

FIG. 9A is a flowchart illustrating an exemplary process 900 for determining position information of a lesion region according to some embodiments of the present disclosure. In some embodiments, the process 900 may be performed to achieve at least part of operation 604 as described in connection with FIG. 3.

In 902, the processing device 140 (e.g., the determination module 220) may generate a registered second segmentation image by registering a second segmentation image and a lesion distribution image. The registered second segmentation image may be generated in a similar manner as how the registered image is generated as described in FIG. 7.

In 904, the processing device 140 (e.g., the determination module 220) may generate a second fusion image by fusing the registered second segmentation image and the lesion distribution image. The second fusion image may be a lesion distribution image marked with body parts of the target subject. That is, the second fusion image may include information of the second segmentation image and information of the lesion distribution image. The second fusion image may be generated in a similar manner as how the fusion image is generated as described in FIG. 7.

In 906, the processing device 140 (e.g., the determination module 220) may determine, based on the second fusion image, position information of a lesion region in the target subject.

The position information determined based on the second fusion image may indicate which body part the lesion region is located at. For example, as illustrated in FIG. 9B, an image 910 is a lesion distribution image, and an image 920 is a second segmentation image. By registering the image 910 and the image 920 and generating a second fusion image, a first lesion region 902 in the image 910 may be determined as being located at a neck part, and a second lesion region 904 in the image 910 may be determined as being located at a chest part.

Processes 300, 400, and 600-900 may be implemented in the imaging system 100 illustrated in FIG. 1. For example, the processes 300, 400, and 600-900 may be stored in the storage device 150 in the form of instructions (e.g., an application), and invoked and/or executed by the processing device 140. The operations of the illustrated process presented below are intended to be illustrative. In some embodiments, the processes 300, 400, and 600-900 may be accomplished with one or more additional operations not described, and/or without one or more of the operations discussed. Additionally, the order in which the operations of the processes 300, 400, and 600-900 as illustrated in FIGS. 3, 4, and 6-9A as described below is not intended to be limiting.

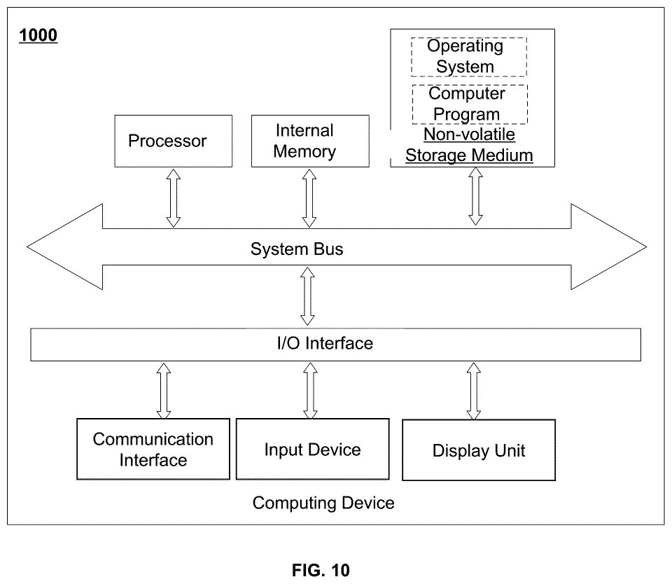

FIG. 10 is a schematic diagram illustrating an exemplary computing device 1000 according to some embodiments of the present disclosure.

In some embodiments, one or more components of the imaging system 100 may be implemented on the computing device 1000. For example, a processing engine may be implemented on the computing device 1000 and configured to implement the functions and/or methods disclosed in the present disclosure.

The computing device 1000 may include any components used to implement the imaging system 100 described in the present disclosure. For example, the processing device 140 may be implemented through hardware, software program, firmware, or any combination thereof, on the computing device 1000. For illustration purposes, only one computer is described in FIG. 10, but computing functions related to the imaging system 100 described in the present disclosure may be implemented in a distributed fashion by a group of similar platforms to spread the processing load of the imaging system 100.

The computing device 1000 may include a communication port connected to a network to achieve data communication. The computing device 1000 may include a processor (e.g., a central processing unit (CPU)), a memory, a communication interface, a display unit, and an input device connected by a system bus. The processor of the computing device 1000 may be used to provide computing and control capabilities. The memory of the computing device 1000 may include a non-volatile storage medium, an internal memory. The non-volatile storage medium may store an operating system and a computer program. The internal memory may provide an environment for the execution of the operating system and the computer program in the non-volatile storage medium. The communication interface of the computing device 1000 may be used for wired or wireless communication with an external terminal. The wireless communication may be realized through Wi-Fi, a mobile cellular network, a near field communication (NFC), etc. When the computer program is executed by the processor, a method for determining feature points may be implemented. The display unit of the computing device 1000 may include a liquid crystal display screen or an electronic ink display screen. The input device of the computing device 1000 may include a touch layer covered on the display unit, a device (e.g., a button, a trackball, a touchpad, etc.) set on the housing of the computing device 1000, an external keyboard, an external trackpad, an external mouse, etc.

Merely for illustration, only one processor is described in FIG. 10. However, it should be noted that the computing device 1000 in the present disclosure may also include multiple processors. Thus operations and/or method steps that are performed by one processor as described in the present disclosure may also be jointly or separately performed by the multiple processors. For example, if the processor of the computing device 1000 in the present disclosure executes both operation A and operation B, it should be understood that operation A and operation B may also be performed by two or more different processors jointly or separately (e.g., a first processor executes operation A and a second processor executes operation B, or the first and second processors jointly execute operations A and B).

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A method for lesion region identification, implemented on a computing device having at least one processor and at least one storage device, the method comprising:
identifying a target region corresponding to at least one reference organ from a first medical image of a target subject;
determining, based on the target region, a reference threshold used for lesion detection; and
identifying, based on the reference threshold, a lesion region from the first medical image.

2. The method of claim 1, wherein the identifying a target region corresponding to at least one reference organ from a first medical image of a target subject includes:
generating a segmentation image of the at least one reference organ by segmenting the at least one reference organ from a second medical image of the target subject, the second medical image being acquired using a second imaging modality different from a first imaging modality corresponding to the first medical image; and
identifying the target region from the first medical image based on the segmentation image.

3. The method of claim 1, wherein the identifying a target region corresponding to at least one reference organ from a first medical image of a target subject includes:
identifying the target region from the first medical image by inputting the first medical image into a reference organ segmentation model, the reference organ segmentation model being a trained machine learning model.

4. The method of claim 1, wherein the determining, based on the target region, a reference threshold used for lesion detection includes:
identifying, from the first medical image, a second target region corresponding to one or more normal organs;
determining, based on the first medical image and the second target region, a comparison coefficient; and
determining, based on the target region and the comparison coefficient, the reference threshold.

5. The method of claim 4, wherein the determining, based on the first medical image and the second target region, a comparison coefficient includes:
determining a remaining region of the first medical image based on the first medical image and the second target region;
determining a first mean value of standard uptake values (SUVs) of elements in the remaining region of the first medical image;
determining a second mean value of SUVs of elements in the first medical image; and
determining the comparison coefficient based on the first mean value and the second mean value.

6. The method of claim 4, wherein the determining, based on the target region and the comparison coefficient, the reference threshold includes:
obtaining SUVs of elements in the target region;
determining a mean value and a standard variance value of the SUVs; and
determining the reference threshold based on the mean value, the standard variance value, and the comparison coefficient.

7. The method of claim 1, further comprising:
generating, based on the lesion region, a lesion distribution image;
obtaining at least one reference segmentation image, the at least one reference segmentation image including at least one of a first segmentation image of organs of the target subject or a second segmentation image of body parts of the target subject; and
determining, based on the lesion distribution image and the at least one reference segmentation image, position information of the lesion region in the target subject.

8. The method of claim 7, wherein the position information includes at least one of: which organ or body part that the lesion region belongs to, a location, a contour, a shape, a height, a width, a thickness, an area, a volume, or a ratio of height to width of the lesion region in the target subject.

9. The method of claim 7, wherein the obtaining at least one reference segmentation image includes at least one of:
generating the first segmentation image by segmenting the organs of the target subject from a second medical image of the target subject; or
generating the second segmentation image by segmenting the body parts of the target subject from a third medical image of the target subject.

10. The method of claim 7, wherein the at least one reference segmentation image includes the first segmentation image and the second segmentation image, and
the determining, based on the lesion distribution image and the at least one reference segmentation image, position information of the lesion region in the target subject includes:
generating a fusion image by fusing the first segmentation image and the second segmentation image, the fusion image being a segmentation image of the organs and the body parts of the target subject;
generating a registered image by registering the fusion image and the lesion distribution image; and
determining, based on the registered image, the position information of the lesion region in the target subject.

11. The method of claim 10, wherein the generating a registered image by registering the fusion image and the lesion distribution image includes:
generating a preliminary point cloud model representing the target subject based on the fusion image;
generating a target point cloud model by transforming the preliminary point cloud model;
generating a transformation image by transforming the fusion image based on the target point cloud model; and
generating the registered image by fusing the transformation image and the lesion distribution image.

12. The method of claim 7, wherein the at least one reference segmentation image includes the first segmentation image, and the determining, based on the lesion distribution image and the at least one reference segmentation image, position information of the lesion region in the target subject includes:
generating a registered first segmentation image by registering the first segmentation image and the lesion distribution image;
generating a first fusion image by fusing the registered first segmentation image and the lesion distribution image; and
determining, based on the first fusion image, the position information of the lesion region in the target subject.

13. The method of claim 7, wherein the at least one reference segmentation image includes the second segmentation image, and the determining, based on the lesion distribution image and the at least one reference segmentation image, position information of the lesion region in the target subject includes:
generating a registered second segmentation image by registering the second segmentation image and the lesion distribution image;
generating a second fusion image by fusing the registered second segmentation image and the lesion distribution image; and
determining, based on the second fusion image, the position information of the lesion region in the target subject.

14. The method of claim 7, further comprising:
generating a report based on the position information of the lesion region in the target subject, the report including text descriptions regarding the position information.

15. A system for lesion region identification, comprising:
at least one storage device including a set of instructions; and
at least one processor configured to communicate with the at least one storage device, wherein when executing the set of instructions, the at least one processor is configured to direct the system to perform operations including:
identifying a target region corresponding to at least one reference organ from a first medical image of a target subject;
determining, based on the target region, a reference threshold used for lesion detection; and
identifying, based on the reference threshold, a lesion region from the first medical image.

16. (canceled)

17. A non-transitory computer readable medium, comprising executable instructions that, when executed by at least one processor, direct the at least one processor to perform a method, the method comprising:
identifying a target region corresponding to at least one reference organ from a first medical image of a target subject;
determining, based on the target region, a reference threshold used for lesion detection; and
identifying, based on the reference threshold, a lesion region from the first medical image.

18-22. (canceled)

23. The system of claim 15, wherein the identifying a target region corresponding to at least one reference organ from a first medical image of a target subject includes:
generating a segmentation image of the at least one reference organ by segmenting the at least one reference organ from a second medical image of the target subject, the second medical image being acquired using a second imaging modality different from a first imaging modality corresponding to the first medical image; and
identifying the target region from the first medical image based on the segmentation image.

24. The system of claim 15, wherein the determining, based on the target region, a reference threshold used for lesion detection includes:
identifying, from the first medical image, a second target region corresponding to one or more normal organs;
determining, based on the first medical image and the second target region, a comparison coefficient; and
determining, based on the target region and the comparison coefficient, the reference threshold.

25. The system of claim 24, wherein the determining, based on the first medical image and the second target region, a comparison coefficient includes:
determining a remaining region of the first medical image based on the first medical image and the second target region;
determining a first mean value of standard uptake values (SUVs) of elements in the remaining region of the first medical image;
determining a second mean value of SUVs of elements in the first medical image; and
determining the comparison coefficient based on the first mean value and the second mean value.

26. The system of claim 24, wherein the determining, based on the target region and the comparison coefficient, the reference threshold includes:
obtaining SUVs of elements in the target region;
determining a mean value and a standard variance value of the SUVs; and
determining the reference threshold based on the mean value, the standard variance value, and the comparison coefficient.
